(19) United States
(12) Patent Application Publication
(10) Pub. No.: US 2004/0115505 A1
(43) Pub. Date: Jun. 17, 2004

(54) Fuel cell separator molding method and molding die

(75) Inventor: Yosuke Oyama, Aichi-ken (JP)

Correspondence Address: BROWDY AND NEIMARK, P.L.L.C., 624 NINTH STREET, NW, SUITE 300, WASHINGTON, DC, 20001-5303, US

(73) Assignee: Kabushiki Kaisha Meiki Seisakusho, Aichi-ken (JP)

(21) Appl. No.: 10/717,515

(22) Filed: Nov. 21, 2003

(30) Foreign Application Priority Data
Dec. 10, 2002 (JP) 2002-358185

(51) Int. Cl. H01M 8/02; B29D 31/00

(52) U.S. Cl. 429/34; 264/319

(57) ABSTRACT

In order to mold a plurality of PEFC separators, each of which is free of warpage and has a substantially uniform thickness at one time by using an electrically conductive melted material having poor flowability, there is provided an molding method of the fuel cell separators P1 for molding the electrically conductive melted material M in a cavity 3 that is comprised of a stationary die 1 and a movable die 2, the cavity has a variable volume and a plurality of separator molding portions are connected to each other in one cavity and, after or while the electrically conductive melted material is supplied to the cavity, the movable die is moved toward the stationary die to reduce the volume of the cavity, so that a plurality of fuel cell separators are molded at one time.

### BACKGROUND OF THE INVENTION

1. Field of the Invention

The present invention relates to a molding method, and a molding die, for a separator for a polymer electrolyte fuel cell (hereinafter referred to as a PEFC separator) or the PEFC separator that is molded by said molding method.

2. Description of the Related Art

A PEFC separator for a vehicle is, for example, a plate-like article, of dimensions approximately the same as an A4 sheet, that has many grooves on both sides for circulating oxygen gas and hydrogen gas. Typically, the PEFC separator has an overall thickness of 2 mm or less and, on account of the existence of the grooves on both sides, is 0.5 mm thick, or less, at the thinnest part. As one PEFC is constituted by stacking several hundred PRFC separators, each PEFC separator is required to be free of warpage and to have a uniform thickness.

Conventionally, there is publicly known a molding method for the PEFC separator wherein the PEFC separator is molded by compression molding or injection molding using a mixture in which an epoxy resin of 15 parts or less and a curing agent of 9 parts or less are mixed with a graphite of 100 parts by weight. Further, there is also publicly known another method of machining or laminating press of molded products (for example, see Japanese Unexamined Patent Publication (Kokai) 2001-216976).

Though Japanese Unexamined Patent Publication (Kokai) 2001-216976 mentioned above describes several methods for molding only one PEFC separator at one time, it does not describe any method for molding a plurality of PEFC separators at one time. In the case of compression molding, if a plurality of PEFC separators are to be molded at one time, it is contemplated that a melted material is supplied to each cavity and pressurized at one time but, if there is only a slight difference in volumes of the supplied melted material between said cavities, a movable die and a stationary die cannot be kept horizontal to each other and, therefore, the thickness of the molded PEFC separators cannot be uniform. On the other hand, if the melted material is supplied to each cavity sequentially and not at the same time, there is a problem in that thermal hysteresis of the melted material may vary and an unevenness between the molded PEFC separators may occur.

Further, in the case of injection molding, if a plurality of PEFC separators are to be molded at one time, it is contemplated that a melted material is injected into each cavity but it is difficult to uniformly inject the melted material having poor flowability to the end of each cavity via a runner due to a large pressure loss and, even if the melted material is filled up to the end of the cavities, the thickness of the molded PEFC separators will not be uniform. Further, because it is not possible that a uniform volume of the melted material is supplied to each cavity via the branched runner, when more melted material is supplied to one cavity than to other cavities, the movable die cannot be held horizontal to the stationary die and, as a result, the thickness of the molded PEFC separators cannot be uniform. Still further, there is also another problem in that the melted material in the runner portion is wasted.

### SUMMARY OF THE INVENTION

Thus, in view of the problems described above, it is an object of the present invention to mold a plurality of PEFC separators each of which is free of warpage and has a substantially uniform thickness by using an electrical conductive material having low flowability at one time.

According to the method of the present invention, there is provided a fuel cell separator molding method for molding an electrical conductive melted material in a cavity that is comprised of a stationary die and a movable die, wherein the cavity has a variable volume and a plurality of separator molding portions are connected to each other in one cavity, after or while the electrical conductive melted material is supplied to the cavity, the movable die is moved toward the stationary die to reduce the volume of the cavity, so that a plurality of fuel cell separators are molded at one time.

These and other objects, features and advantages of the present invention will become more apparent upon reading of the following detailed description along with the accompanied drawings.

According to the object of the present invention, there is provided a fuel cell separator molding die for injecting an electrical conductive melted material into a cavity that is comprised of a stationary die and a movable die, wherein the cavity has a variable volume and a plurality of separator molding portions are connected to each other in one cavity, and the electrical conductive melted material is provided so that it can be supplied directly through a gate portion only or through a sprue portion and the gate portion only.

According to the object of the present invention, there is provided a fuel cell separator that is molded by the fuel cell separator molding method described above and, then, separated into individual pieces.

### BRIEF DESCRIPTION OF THE DRAWINGS

FIG. 1 is a front view of a stationary die used in an injection compression molding method for a PEFC separator;

FIG. 2 is a cross sectional view of a molding die used for the injection compression molding of the PEFC separator, wherein a central cross section is shown above line A-A and another cross section at the nearer side is shown below the line;

FIG. 3 is a perspective view of a molded product that is comprised of a plurality of PEFC separators molded by the injection compression molding method;

FIGS. 4A-4C are cross sectional views of connecting portions of the molded product that is comprised of a plurality of PEFC separators; and

FIG. 5 is a perspective view of a molding die used in an injection compression molding method for a PEFC separator in another embodiment.

### DESCRIPTION OF THE PREFERRED EMBODIMENTS

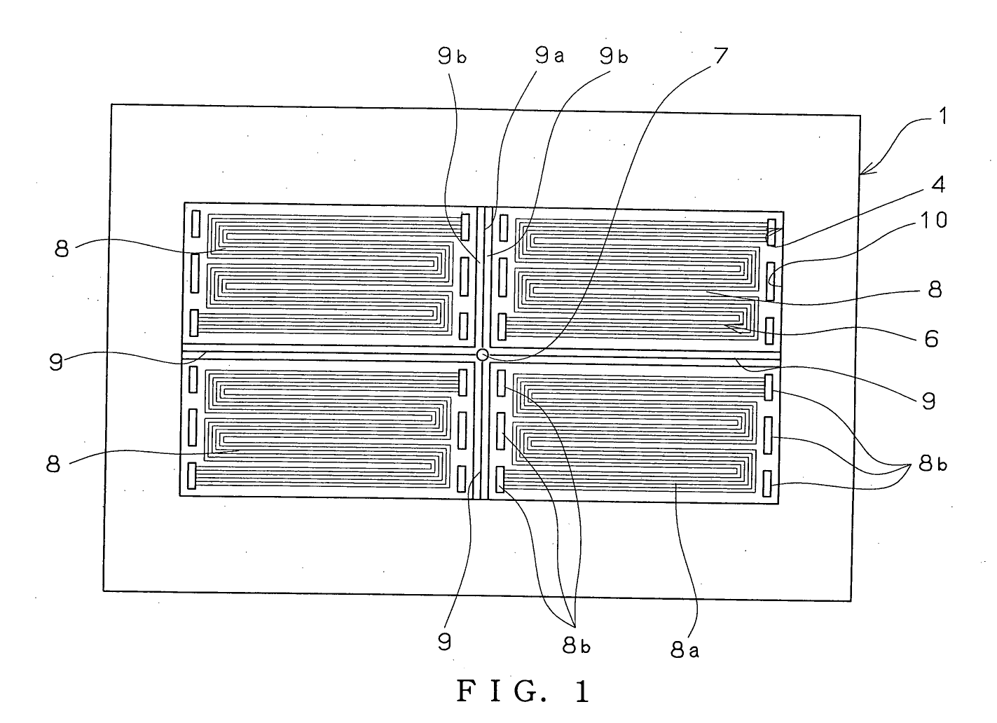

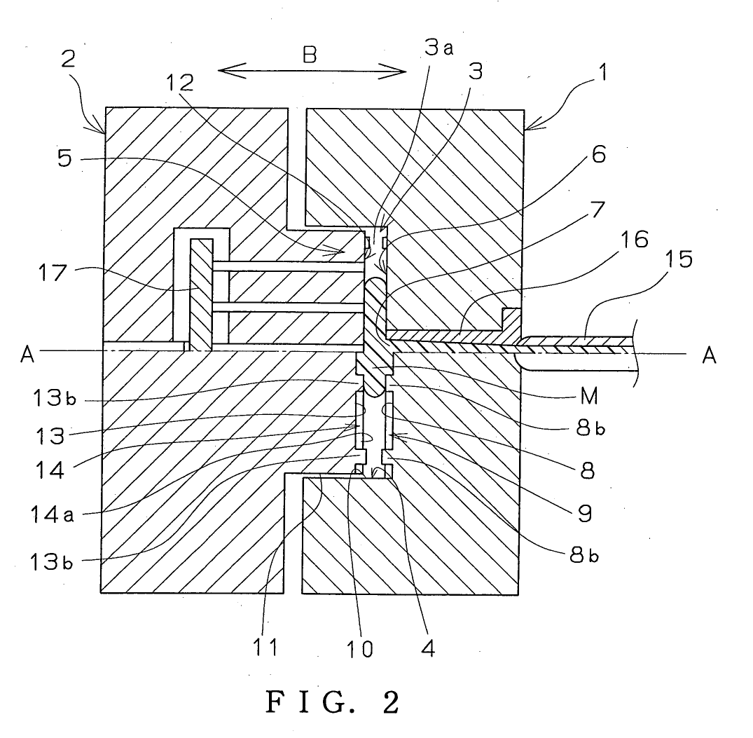

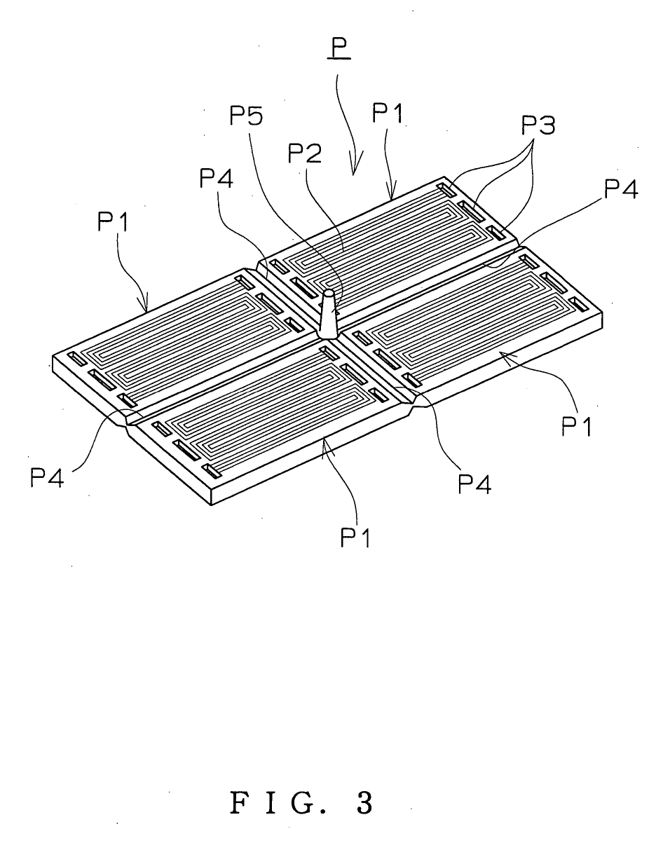

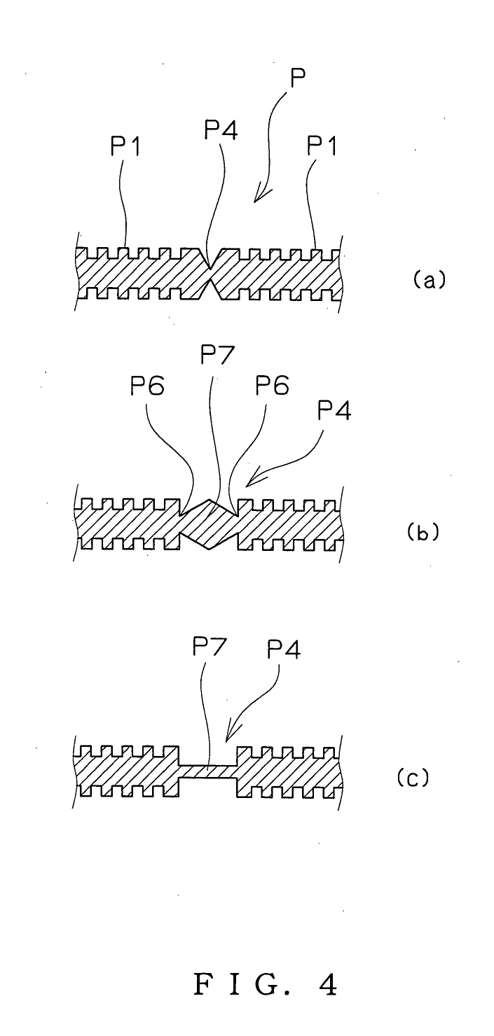

An embodiment of the present invention will be described with reference to FIGS. 1-4. FIG. 1 is a front view of a stationary die used for injection compression molding of a PEFC separator. FIG. 2 is a cross sectional view of a molding die used for the injection compression molding of the PEFC separator, wherein a central cross section is shown above line A-A and another cross section at the nearer side is shown below the line. FIG. 3 is a perspective view of a molded product that is comprised of a plurality of PEFC separators molded by the injection compression molding. FIGS. 4A-4C are cross sectional views of connecting portions of the molded product that is comprised of a plurality of PEFC separators.

A molding die for a PEFC separator shown in FIGS. 1 and 2 is used for injection compression molding wherein an electrically conductive melted material M is compressed after injection. A cavity 3, which is formed between a stationary die 1 attached to a stationary platen (not shown) and a movable die 2 attached to a movable platen (not shown), is provided so that its volume can be variable by moving the movable platen and the movable die 2 with respect to the stationary die 1 by means of actuation of a die clamping device (not shown). Then, in this embodiment, the injection compression molding die for the PEFC separator takes a form of a so-called spigot fitting wherein a protruding portion 5 of the movable die 2 is fitted into a recessed portion 4 of the stationary die 1. Here, the injection compression molding die for the PEFC separator may alternatively be configured so that an outer frame constituting a side wall portion of the cavity of one die is moved in the die opening/closing direction B when it abuts on the other die.

FIG. 1 is a front view of a stationary die. 1 seen from the side of the movable die 2, wherein a cavity forming surface 6 that is substantially rectangular is formed in the recessed portion 4 of the stationary die 1 for forming one cavity 3. The cavity forming surface 6 is provided with a gate portion 7 at the center thereof and has a plurality of separator molding portions 8 around the gate portion 7 and connecting portions 9 that connect said plurality of separator molding portions to each other. Further, a side wall surface 10 of the recessed portion 4 is configured to face to a side wall surface 11 of the protruding portion 5 of the movable die 2 with a slight clearance to prevent the melted material from flowing in. Here, in this embodiment, it is to be noted that the cavity 3 denotes a hollow portion into which the melted material is injected and which is formed between the stationary die 1 and the movable die 2 and is adjacent to the gate portion 7 and which includes not only the separator molding portions 8 but also the connecting portions 9 and the like.

On the cavity forming surface 6 of the stationary die 1, four separator molding portions 8, which are portions where the PEFC separators (the fuel cell separators) are formed, are formed on an identical plane perpendicular to the die opening/closing direction B so that the rectangular cavity forming surface 6 having the gate portion 7 at its center is divided in four parts.

Further describing the configuration of the separator molding portion 8 and the PEFC separator Pl formed by said separator molding portion 8 in this embodiment in more detail with reference to FIGS. 1 and 3, in the separator molding portion 8, there are formed protruding ridges 8a and protruding portions 8b for forming a plurality of groove portions P2 and hole portions P3, respectively, on the surface of the PEFC separator P1. The groove portions P2 formed by the protruding ridges 8a act as passages where hydrogen or air (oxygen) flows along the surface of the PEFC separator P1 in each single PEFC cell in which a PEFC catalyst and an electrode are sandwiched therebetween. On the other hand, the hole portions P3 formed in the PEFC separator P1 act as passages for supplying the hydrogen and air (oxygen) to each PEFC single cell when a plurality of PEFC separator single cells are incorporated into the PEFC.

In this embodiment, the groove portions P2 formed along the surface of the PEFC separator P1 are configured to be folded multiple times from one side to another so that the length of the groove portions P2 are secured. However, the configuration of the groove portions P2 is not limited to the above example and the groove portions P2 may be formed only in one direction from one side to another. Further, the groove portions P2 on the topside and the underside may be provided either in the same direction or in the perpendicular direction. Still further, recessed grooves may be formed on the surface of the separator molding portions 8 so that portions on the PEFC separators P1 corresponding to the recessed grooves act as partitioning portions between the groove portions P2. Moreover, the hole portions P3 of the molded product P may be configured to be thin walled portions during the molding process so as to facilitate flowability of the electrically conductive melted material M and the thin walled portions may be removed to form the hole portions P3 after the completion of the molding process and, further, the hole portions P3 may not be provided depending on the configuration of the PEFC separator P1.

One separator molding portion 8 is connected to the adjacent separator molding portions 8 and 8 by the connecting portions 9 and 9, respectively. In the separator molding portion 8, said side wall surface 10 is formed at the side that is not adjacent Lo the other separator molding portions 8 and 8. Here, it is to be noted that the number of the separator molding portions 8 formed on the cavity forming surface 6 is not limited to four and it may be, for example, two.

The connecting portions 9 on the cavity forming surface 6 are formed in a cross arrangement having the gate portion 7 at the center thereof so that each connecting portion 9 extends from the gate portion 7 toward the side wall surface 10 of the cavity forming surface 6 and abuts perpendicularly on said side wall surface 10. In this embodiment, respective protruding linear portions 9a are formed on the connecting portions 9, on the cavity forming surface 6. Then, at both sides of said protruding linear portions 9a, inclined surfaces 9b and 9b are formed in parallel with the protruding linear portions 9a to form the side surface of the PEFC separator P1. Therefore, in the molded product P shown in FIG. 3, connecting portions P4 in the form of V-grooves are formed by the connecting portions 9 of said stationary die 1 to connect the PEFC separators P1 as shown in FIG. 4A.

Then, describing the movable die 2 with reference to FIG. 2, the movable die 2 is provided with a cavity forming surface 12 on the front side of the protruding portion 5 thereof, wherein the cavity forming surface 12 is substantially rectangular and is formed perpendicularly to the die opening/closing direction to form one cavity 3. The cavity forming surface 12 of the movable die 2 is opposed to the cavity forming surface 6 of the stationary die 1 and, at the respective positions corresponding to the cavity forming surface 6, also has a plurality of separator molding portions 13 and connecting portions 14 for connecting said plurality of separator molding portions 13. Then, the separator molding portions 13 of the movable die 2 are also provided with protruding ridges (not shown) for forming the plurality of groove portions P2 and protruding portions 13b for forming the hole portions P3. Further, the connecting portions. 14 are provided with respective protruding linear portions 14a in a manner similar to the connecting portions 9 of the stationary die 1.

Next, an injection compression molding method of the PEFC separator Pl in this embodiment will be described with reference to FIGS. 1-4. The movable platen and the movable die 2 are moved toward the stationary die 1 by a die opening/closing device (not shown) and the movable die 2 is stopped so that the protruding portions 5 of the movable die 2 abuts on the recessed portion 4 of the stationary die 1 so as to form one cavity 3 having a variable volume between both dies.

The position at which the movable die 2 is stopped as described above is defined so that the volume of the cavity 3 to be formed is 10-200% larger than the total volume of four PEFC separators P1 and the connecting portions P4 included in the molded product P shown in FIG. 3. This stop position is determined optimally according to composition, temperature, pressure and so on of the injected electrical conductive melted material M. Then, the electrical conductive melted material M is injected from a nozzle 15 of an injection device through a sprue bush 16 and the gate portion 7 into the cavity 3. The volume of the injected electrical conductive melted material M corresponds to a sum of the volumes of the all PEFC separators P1 and connecting portions P4, the sprue P5 and the like, which are formed in the cavity 3 at one time.

In this embodiment, the electrical conductive melted material M is a thermosetting resin material such as phenol resin, epoxy resin and the like or a thermoplastic resin material such as polypropylene, polyethylene, polystyrene, polyimide, polyethylene terephthalate, polybutene, polyphenylene sulfide and the like that contain 60-95% by weight or, more preferably, 75-85% by weight of an electrically conductive filler. Further, the electrical conductive melted material is not limited to the resin materials mentioned above and any metallic material may be added.

Then, after the electrical conductive melted material M is injected into the cavity 3 and it is detected that a screw is advanced in the injection device to a predetermined position, the die clamping device (not shown) is activated so that the movable platen and the movable die 2 are moved again toward the stationary die 1 so as to reduce the volume of the cavity 3. At this time, it is desirable that the movable die 2 is moved at a speed of 2 mm/sec-50 mm/sec. Then, the electrical conductive melted material M injected into the cavity 3 is pressurized by said movement of the movable die 2 and filled uniformly throughout the plurality of separator molding sections 3a in the cavity 3 formed between the separator molding sections 8 and 13.

At this time, as the plurality of separator molding sections 3a in the cavity 3 are connected to each other by a space formed between the connecting portions 9 and 14, even if the electrical conductive melted material M is injected into only one of the plurality of separator molding portions 3a in the cavity 3 unevenly, the electrical conductive melted material M flows into other separator forming sections through the space between the connecting portions 9 and 14 and, eventually, the electrical conductive melted material M is injected and filled into each separator molding portion 3a in the cavity 3 uniformly.

Then, when the movable die 2 abuts on the stationary die 1 or reaches a predetermined position or pressure, the movement of the movable die 2 is stopped. As the separator molding portions 3a in the cavity 3 is configured so that its thickness conforms to the thickness of the PEFC separators Pl to be molded at the position where the movable die 2 is stopped, the protruding portions 8b and 13b are abutted on each other so as to form the hole portions P3. Further, the connecting portions P4 that take the form of V-grooves as shown in FIG. 4A are formed between the connecting portions 9 and 14. Then, after the movement of the movable die 2 is stopped, a thermosetting or cooling process is performed for a predetermined time period. Then, after hardening of the PEFC separators P1, by either the thermosetting or the cooling, is completed, the movable die 2 is moved in the die opening direction so that the molded product P that consists of the plurality of PEFC separators P1, the connecting portions P4 and the sprue P5 as shown in FIG. 3 is removed from the stationary die 1.

After that, said molded product P that remains in the movable die 2 is pushed out by an ejector device 17 of the movable die 2 and drawn out by aspiration by an unloading device (not shown). Then, said molded product P is divided at the connecting portions P4 into each PEFC separator P1. Surfaces of the divided portions of the PEFC separators may be finish-machined as needed.

Besides the example shown in FIG. 4A, the connecting portions P4 of the molded product P may alternatively be configured as shown in FIG. 4B, wherein two protruding linear portions in the die opening/closing direction are formed between the adjacent separator molding portions 8 and 8 on the dies so that two groove portions P6 and P6 are provided at the side of the molded product P. In this case, the PEFC separators P1 and P1 are divided by the two groove portions P6 and P6 and excess portions P7 remain between the two groove portions P6 and P6. Further, as shown in FIG. 4C, protruding planar portions may be provided on the dies in a strip-like manner so that strip-like thin walled excess portions P7 are formed in the molded product P.

Further, as a variation of the embodiment described above, the die clamping may be started as soon as the injection is started or the movable die 2 may be moved temporarily in the die opening direction in response to injection. Still further, in order to improve the flowability of the electrically conductive melted material M, the air in the cavity 3 may be evacuated before injection. Moreover, two or more gate portions 7 and injection devices may be connected to the cavity 3. Further, with the aim of increasing injection speed and making the injection volume uniform, the injection may be performed by a plunger.

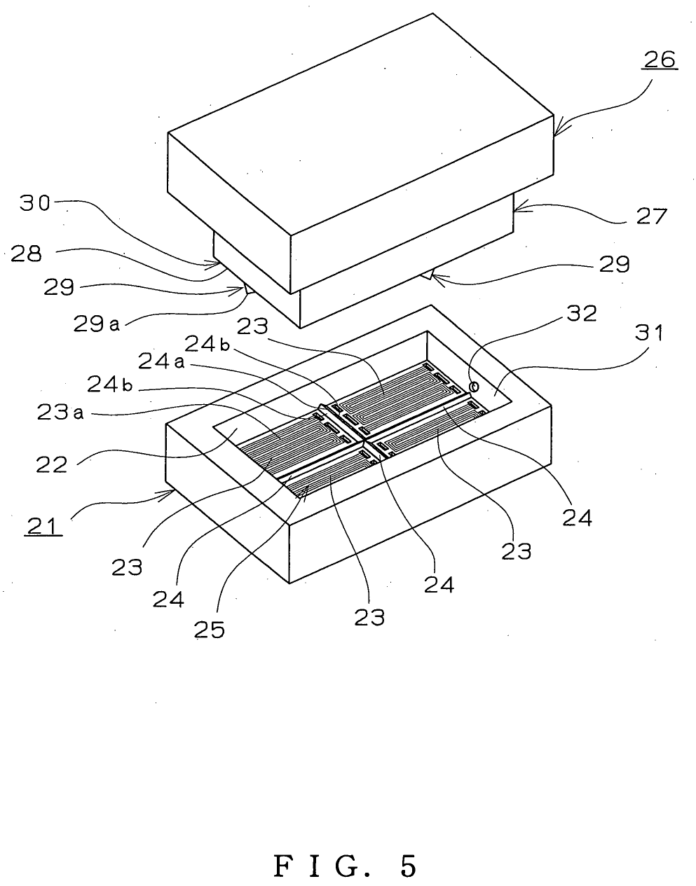

Next, another embodiment shown in FIG. 5 will be described. In an injection compression molding die for a PEFC separator shown in FIG. 5, a cavity forming surface 25 having a plurality of separator molding portions 23 and connecting portions 24 on an identical plane is formed in a recessed portion 22, which is formed in a stationary die 21 acting as a bottom die. Then, also, on a protruding portion 27 of a movable die 26 acting as a top die, a cavity forming surface 30 having separator molding portions 28 and connecting portions 29 is formed and, as the protruding portion 27 of said movable die 26 is fitted into the recessed portion 22 of said stationary die 21 in the form of a spigot fitting, a cavity is provided so that its volume can be variable.

Then, a gate portion 32 that is connected to the cavity is provided on a side wall surface 31 of the recessed portion 22 in the stationary die 21. In the embodiment shown in FIG. 5, said gate portion 32 is formed at the lateral side of the cavity. Then, in the gate portion 32, a nozzle (not shown) is formed so that it is exposed from the lateral side. Thus, said gate portion 32 is configured so that it can be closed by movement of the protruding portion 27 of the movable die 0.26 in the die closing direction. The shape of the gate portion 32 is not limited to a circle and it may be an ellipse. Further, in view of flowability of an injected electrical conductive melted material M, it is desirable that the direction of the side wall surface 31 on which the gate portion 32 is provided conforms to the direction of protruding ridges 23a on the separator molding portions 23.

Further, on the cavity forming surface 25 of the stationary die 21, the connecting portions 24 are formed as protruding linear portions 24a between the separator molding portions 23 and 23 and, on both sides of the protruding linear portions 24a, inclined surfaces 24b and 24b are formed on the separator molding portions 23 and 23. Similarly, also on the movable die 26, the connecting portions 29a and other elements are formed.

An injection molding method of the embodiment shown in FIG. 5 is basically similar to the one in the above embodiment shown in FIG. 1 and so on, wherein a molded product P is molded by injecting the electrically conductive melted material M from the nozzle through the gate portion 32 into the cavity and, then, lowering the movable die 26 with respect to the stationary die 21 to reduce the volume of the cavity. However, in the embodiment shown in FIG. 5, because the gate portion 32 is connected to the lateral side of the cavity directly, the sprue P5 is not formed. Further, when the die is opened after the molding process is completed, the molded product P remains in the stationary die 21 and the entire bottom surface portion in the cavity forming surface 25 of said stationary die 21 is lifted up so that the molded product P is taken out.

Further, the present invention may be applied to compression molding. Though not shown in the drawings, in the molding die used for the compression molding, a cavity forming surface having a plurality of separator molding portions and connecting portions on an identical plane is formed in a recessed portion, which is, in turn, formed in a stationary die acting as a bottom die. Then, also on a protruding portion 27 of a movable die acting as a top die, a cavity forming surface having separator molding portions and connecting portions is formed. It is to be noted that the molding die used for compression molding is not provided with a gate portion as in the case of the molding die for injection compression molding described above. Thus, the molding is performed by supplying an electrical conductive melted material M to the recessed portion of said stationary die from a supply means and, then, pressurizing the electrical conductive melted material M by the protruding portion of the movable die so that the electrical conductive melted material M is extended in the cavity.

According to the present invention, in a molding method for molding a fuel cell separator by injecting an electrically conductive melted material into a cavity that is comprised of a stationary die and a movable die, after the electrically conductive melted material is injected into the cavity that has a variable volume and has a plurality of separator molding portions and connecting portions that connect the plurality of separator molding portions to each other, the movable die is moved toward the stationary die to reduce the volume of the cavity so that a plurality of fuel cell separators are molded at one time, wherein, even if an electrically conductive melted material having poor flowability is used, a plurality of fuel cell separators each of which is free of warpage and has a substantially uniform thickness can be molded at one time and, therefore, this method is suitable for mass production of the fuel cell separators.

What is claimed is:

1. A fuel cell separator molding method for molding an electrically conductive melted material in a cavity that is comprised of a stationary die and a movable die, wherein
said cavity has a variable volume and a plurality of separator molding portions are connected to each other in one cavity, and
after or; while said electrically conductive melted material is supplied to said cavity, the movable die is moved toward the stationary die to reduce the volume of said cavity, so that a plurality of fuel cell separators are molded at one time.

2. A fuel cell separator molding method according to claim 1, wherein the electrically conductive melted material is supplied to said cavity from one supply means and is compression molded.

3. A fuel cell separator molding method according to claim 1, wherein the electrically conductive melted material is supplied to said cavity from an injection device, directly through a gate portion only or through a sprue portion and the gate portion only and is injection compression molded.

4. A fuel cell separator molding method according to claim 1, wherein said electrically conductive melted material is a melted resin material containing 60-95% by weight of an electrically conductive filler.

5. A fuel cell separator molding die for injecting an electrically conductive melted material into a cavity that is comprised of a stationary die and a movable die, wherein
said cavity has a variable volume and a plurality of separator molding portions are connected to each other in one cavity, and
the electrically conductive melted material is provided so that it can be supplied directly through a gate portion only or through a sprue portion and the gate portion only.

6. A fuel cell separator that is molded by the fuel cell separator molding method according to claim 1 and, then, separated into each piece.
